(19) United States
(12) Patent Application Publication
(10) Pub. No.: US 2022/0132892 A1
(43) Pub. Date: May 5, 2022

(54) FOOD THAWING CABINET AND RELATED METHODS

(71) Applicant: ILLINOIS TOOL WORKS INC., Glenview, IL (US)

(72) Inventors: Austin M. BIERI, Burleson, TX (US); Steven T. JACKSON, Fort Worth, TX (US); Henry L. NGUYEN, Haltom City, TX (US)

(21) Appl. No.: 17/502,226

(22) Filed: Oct. 15, 2021

Related U.S. Application Data
(60) Provisional application No. 63/107,897, filed on Oct. 30, 2020.

(51) Int. Cl. A23L 3/365

(52) U.S. Cl. CPC A23L 3/365

(57) ABSTRACT

A food thawing apparatus includes a cabinet structure defining a thawing chamber accessible by at least one door, and a plurality of air movers and associated air flow structure configured for causing air flow through the thawing chamber such that multiple air flow circuits are set up within the cabinet structure. The cabinet structure defines a vertically extending flow section alongside the thawing chamber. A refrigeration system includes a condenser section and an evaporator section. In one example, the multiple air flow circuits include: a first air flow circuit that runs through the flow section, into and through the thawing chamber, into and through the evaporator section and back to the flow section; and a second air flow circuit from the flow section, through a first set of the plurality of shelves and back to the flow section, without passing through the evaporator section.

### TECHNICAL FIELD

The present application relates generally to cabinets utilized for thawing frozen foods, and more particularly to a food thawing cabinet for rapidly thawing frozen foods in a controlled manner.

### BACKGROUND

It is known to provide thawing cabinets for thawing frozen food products in commercial environments such as restaurants and cafeterias. Achieving high speed thawing is an important consideration. Air flow over the food products is a critical feature to effective and timely food thawing.

It would be desirable to provide an air flow arrangement that enhances thawing and improves upon the thawing time achievable in food thawing cabinets.

### SUMMARY

In one aspect, a food thawing apparatus incorporates convection thawing by air flow, where multiple air flow circuits are employed for effective air movement over the food product.

In another aspect, a food thawing apparatus includes a cabinet structure defining a thawing chamber, and a plurality of air movers and associated air flow structure configured for causing air flow through the thawing chamber such that multiple air flow circuits are set up within the cabinet structure.

In a further aspect, a food thawing apparatus includes a cabinet structure defining a thawing chamber accessible by at least one door, and a plurality of air movers and associated air flow structure configured for causing air flow through the thawing chamber such that multiple air flow circuits are set up within the cabinet structure. The cabinet structure defines a vertically extending flow section alongside the thawing chamber. A refrigeration system includes a condenser section and an evaporator section. The multiple air flow circuits include: a first air flow circuit that runs through the flow section, into and through the thawing chamber, into and through the evaporator section and back to the flow section; and a second air flow circuit from the flow section, through a first set of the plurality of shelves and back to the flow section, without passing through the evaporator section.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is perspective view of a thawing apparatus;

FIG. 2 is a front schematic view of the thawing apparatus;

FIG. 3 is a partial perspective view of the apparatus with front doors and right side wall removed;

FIG. 4 is a partial top perspective with top section removed;

FIG. 5 is a partial section perspective showing the flow section of the apparatus with air movers and duct panels; and

FIGS. 6A and 6B are front schematic views with air circuits shown.

### DETAILED DESCRIPTION

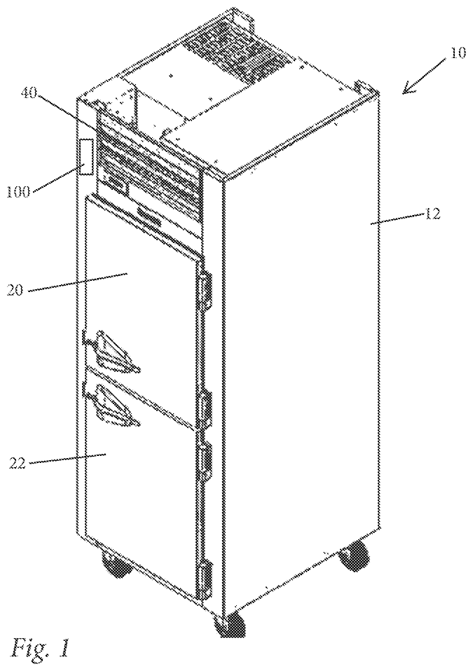

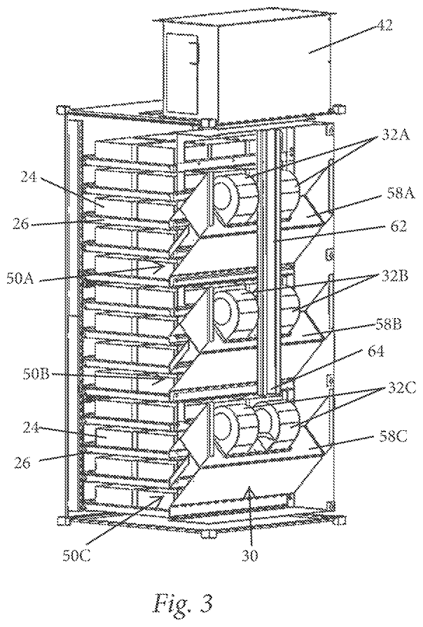

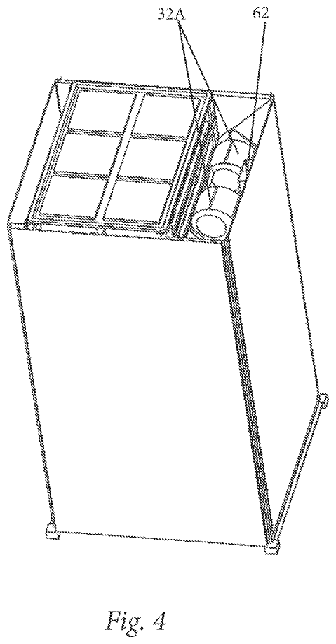

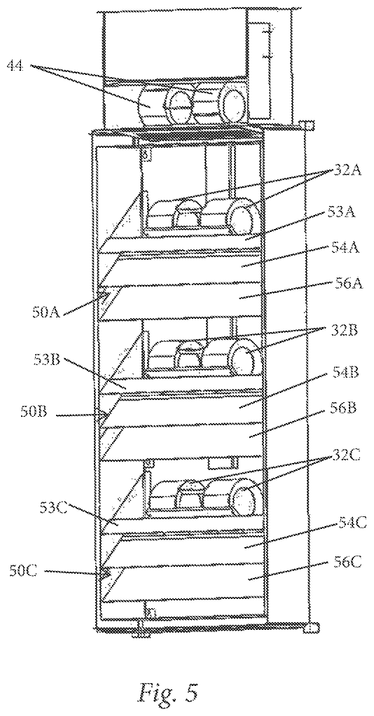

Referring to FIGS. 1-5, a food thawing apparatus 10 includes a cabinet structure 12 with an internal thawing chamber 14. Here, upper and lower doors 20 and 22 are provided for enabling access to the chamber 14, but single door units are also possible. A side chamber or flow section 30 of the cabinet includes a plurality of air movers 32A-32C for generating air flows into and out of the chamber 14 so as to thaw the food products 24, which products may be supported on shelves 26 within the chamber 14. An upper section 34 of the apparatus 10 supports a refrigeration system 36 that includes a condenser section 38 that is substantially closed off from air flow to the chamber 14, but open to air flow to the ambient environment by a louvered opening 40. The refrigeration system also includes an evaporator section 42 with one or more air movers 44 to pull air from the chamber 14 and move it across the evaporator coil 46 of the evaporator section 42. In the illustrated embodiments, the air movers 32A-32C and 44 are depicted as centrifugal fans, but other types of air movers (e.g., axial fans or other fans) could also be utilized.

The air movers 32A-32C are positioned and oriented with respect to ducting, such as duct panel sets 50A-50C, so as to output air primarily along flow paths 51A-51C and 52A-52C running directionally downward and laterally (here leftward), between duct panel pairs 53A and 54A and 54A and 56A, 53B and 54B and 54B and 56B and 53C and 54C and 54C and 56C. The air movers 32A-32C are mounted with outlet openings in the plane of mount panels 58A, 58B and 58C for this purpose, and each of the panels 53A-53C, 54A-54C and 56A-56C extends at an angle of approximately forty-five degrees (e.g., between 40 and fifty degrees) relative to horizontal. The air mover 44 is positioned and oriented so as to output air primarily along downward flow path 60, toward the right side of the flow section 30. The right side also includes a central vertical duct 62 that extends down and terminates with its lower outlet end 64 at a vertical height proximate to the lower air mover(s) 32C. This duct 62 helps assure sufficient air travel down to the lower air mover(s) 32C.

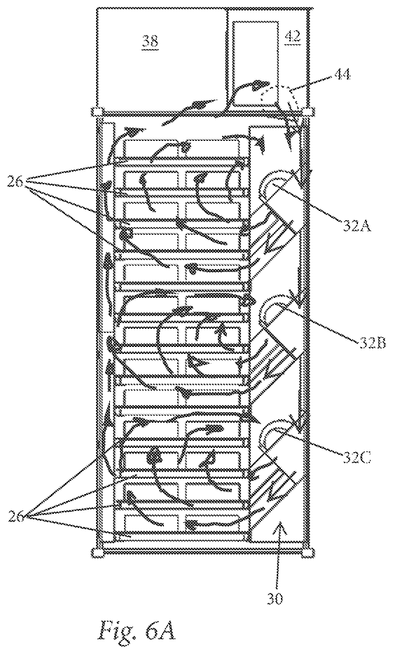

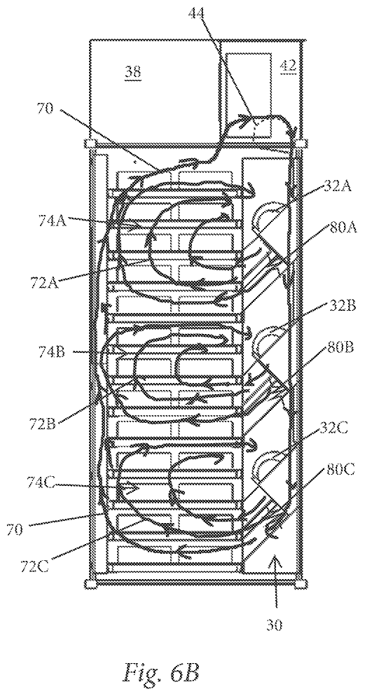

As best seen in FIGS. 6A and 6B, the overall air flow achieved by the arrangement of air movers and duct panels sets up multiple air flow circuits within the cabinet. In particular, a primary air flow circuit 70 runs downward along the flow section 30, through the air movers 32A-32C, toward and through the food product shelves and over the food products, upward to the top of the chamber 14, up through the evaporator section 42, and then back down through the air mover(s) 44. Multiple secondary air flow circuits 72A-72C are also set up within the chamber, where each circuit 72A-72C is primarily a circular or vortex flow within a respective chamber region 74A-74C defined by a number of the shelves 26 (e.g., between 3-5 shelves). Thus, the primary air flow circuit 70 effectively envelopes the secondary air flow circuits 72A-72C, at least within the thawing chamber. However, leakage or mixing of the air between the various air flow circuits is also regularly occurring, which helps assure more uniform temperature conditions throughout the chamber 14 for the purpose of thawing the food product. Placement of the flow section 30 at a location aligned below the outlet flow 60 allows the outlet flow 60 from the evaporator section 42 to supplement or assist the flow down through the flow section 30. As used herein, the term “primary air flow circuit” is used to refer to an air flow circuit that passes through the evaporator section, and the term “secondary air flow circuit” is used to refer to an air flow circuit that does not pass through the evaporator section. The terms “primary” and “secondary”, as used in this context, are not intended to be limited by way of relative importance of the air flow or amount of the air flow.

In this regard, one or more heating elements 80A-80C may also be located within the flow section 30 for heating air prior to passing it from the interior of the flow section 30 into the thawing chamber 14. A temperature sensor 82 may be provided for sensing a temperature of air delivered from the flow section 30 to the thawing chamber 14. A controller 100 of the apparatus is associated with the components, including the heating elements 80A-80C and the air movers 32A-32C and 44, to carry out food product thawing operations, during which the air temperature can be maintained at or around a desired set point, such as in a desired range, such as between 36° F.-39° F. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof.

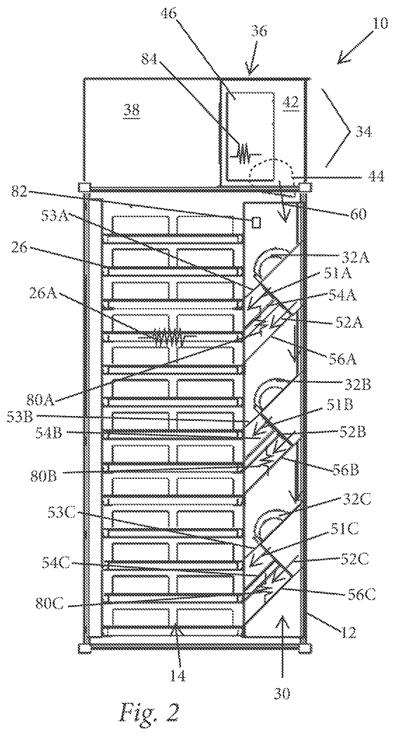

Heat can also be selectively added to the system by other heaters, which may be included in some embodiments. For example, the evaporator section 42 may include a defrost heating element 84 that can be operated to add heat. Moreover, in some embodiments, the shelves 26 themselves could include integrated heating elements (e.g., per element 26A in FIG. 2) that heat the shelves to add heat directly to the food product sitting on the shelves, as well as some heat to the moving air within the cabinet.

It is to be clearly understood that the above description is intended by way of illustration and example only, is not intended to be taken by way of limitation, and that other changes and modifications are possible.

What is claimed is:

1. A food thawing apparatus, comprising:
a cabinet structure defining a thawing chamber;
a plurality of air movers and associated air flow structure configured for causing air flow through the thawing chamber such that multiple air flow circuits are set up within the cabinet structure.

2. The food thawing apparatus of claim 1, further comprising:
the cabinet structure defining a flow section alongside the thawing chamber, and the thawing chamber including a plurality of shelves therein;
a refrigeration system including a condenser section and an evaporator section;
wherein the multiple air flow circuits include:
a primary air flow circuit that runs through the flow section, into and through the thawing chamber, into and through the evaporator section and back to the flow section;
a first secondary air flow circuit from the flow section, through a first set of the plurality of shelves and back to the flow section, without passing through the evaporator section;
a second secondary air flow circuit from the flow section, through a second set of the plurality of shelves and back to the flow section, without passing through the evaporator section.

3. The food thawing apparatus of claim 2, wherein the multiple air flow circuits further include a third secondary air flow circuit from the flow section, through a third set of the plurality of shelves and back to the flow section, without passing through the evaporator section.

4. The food thawing apparatus of claim 2, wherein the primary air flow circuit at least partly envelopes each of the secondary air flow circuits.

5. The food thawing apparatus of claim 1, further comprising:
the cabinet structure defining a flow section alongside the thawing chamber, and the thawing chamber including a plurality of shelves therein;
wherein the multiple air flow circuits include:
a first air flow circuit from the flow section, through a first set of the plurality of shelves and back to the flow section;
a second air flow circuit from the flow section, through a second set of the plurality of shelves and back to the flow section;
wherein the first air flow circuit is vertically offset from the second air flow circuit.

6. The food thawing apparatus of claim 5, wherein the flow section includes at least one first air mover that drives the first air flow circuit, and at least one second air mover that drives the second air flow circuit.

7. The food thawing apparatus of claim 6, wherein the at least one first air mover is vertically spaced apart from the at least one second air mover.

8. The food thawing apparatus of claim 7, wherein:
the at least one first air mover includes associated first ducting, with the at least one first air mover and first ducting oriented to drive air from the flow section in a direction downward and into the thawing chamber;
the at least one second air mover includes associated second ducting, with the at least one second air mover and second ducting oriented to drive air from the flow section in a direction downward and into the thawing chamber.

9. The food thawing apparatus of claim 5, wherein:
the first air flow circuit is primarily a circular or vortex flow that passes through a first chamber region defined by the first set of the plurality of shelves;
the second air flow circuit is primarily a circular or vortex flow that passes through a second chamber region defined by the second set of the plurality of shelves.

10. The food thawing apparatus of claim 5, further comprising:
a third air flow circuit from the flow section, through a third set of the plurality of shelves and back to the flow section;
wherein the third air flow circuit is vertically offset from both the second air flow circuit and the third air flow circuit.

11. The food thawing apparatus of claim 10, wherein the flow section includes at least one first air mover that drives the first air flow circuit, at least one second air mover that drives the second air flow circuit and at least one third air mover that drives the third air flow circuit.

12. The food thawing apparatus of claim 1, further comprising:
at least one air heating element positioned for heating moving air;
an air temperature sensor;
a controller configured for controlling the air movers and the at least one air heating element so as to thaw the food product, wherein the controller is configured to control the at least one air heating element to maintain a temperature of moving air at or around a set point.

13. A food thawing apparatus, comprising:
a cabinet structure defining a thawing chamber accessible by at least one door;
a plurality of air movers and associated air flow structure configured for causing air flow through the thawing chamber such that multiple air flow circuits are set up within the cabinet structure;
wherein the cabinet structure defines a vertically extending flow section alongside the thawing chamber;
a refrigeration system including a condenser section and an evaporator section;
wherein the multiple air flow circuits include:
a first air flow circuit that runs through the flow section, into and through the thawing chamber, into and through the evaporator section and back to the flow section; and
a second air flow circuit from the flow section, through a first set of the plurality of shelves and back to the flow section, without passing through the evaporator section.

14. The food thawing apparatus of claim 13,
a third air flow circuit from the flow section, through a second set of the plurality of shelves and back to the flow section, without passing through the evaporator section.

15. The food thawing apparatus of claim 13, further comprising:
at least one heating element in the flow section for heating air of the second air flow circuit before the air enters the thawing chamber;
an air temperature sensor;
a controller configured for controlling the air movers and the at least one air heating element, wherein the controller is configured to control the at least one air heating element to maintain a temperature of moving air at or around a set point.

16. The food thawing apparatus of claim 13, wherein at least some leakage or mixing of air as between the first air flow circuit and the second air flow circuit occurs.

17. A method of thawing food product, comprising:
utilizing a thawing apparatus with a thawing chamber that includes a plurality of shelves supporting food product, a vertically extending air flow section alongside the thawing chamber and a refrigeration system including an evaporator section;
driving air flow so as to achieve:
a first air flow circuit that runs through the flow section, into and through the thawing chamber, into and through the evaporator section and back to the flow section;
a further air flow circuit from the flow section, through at least some of the plurality of shelves and back to the flow section, without passing through the evaporator section.

18. The method of claim 17, wherein at least part of the first air flow circuit at least partly envelopes the further air flow circuit, at least within the thawing chamber.
